(19) United States
(12) Patent Application Publication
(10) Pub. No.: US 2023/0177853 A1
(43) Pub. Date: Jun. 8, 2023

(54) Methods and Systems for Visual Item Handling Guidance

(71) Applicant: ZEBRA TECHNOLOGIES CORPORATION, Lincolnshire, IL (US)

(72) Inventor: Michael Robustelli, Smithtown, NY (US)

(21) Appl. No.: 17/542,050

(22) Filed: Dec. 3, 2021

(51) Int. Cl. G06V 20/70; G06T 7/73; G06Q 10/08; G06V 10/22; G06V 20/64

(52) U.S. Cl. CPC G06V 20/70; G06T 7/74; G06Q 10/087; G06V 10/235; G06V 20/64

(57) ABSTRACT

A method in a computing device includes: obtaining a task definition including an item identifier; obtaining visual guide data associated with the task definition, the visual guide data including: (i) a reference image depicting an area of a facility corresponding to the identified item, and (ii) a guide element indicating a location for the identified item within the area; and presenting the visual guide data on a display located in an area distinct from the area of the facility corresponding to the identified item.

### BACKGROUND

Environments such as warehousing facilities and retail facilities may house a wide variety of items. The size of such facilities, as well as the breadth of items stored therein, may hinder the efficient location and retrieval of the items.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a facility containing a mobile computing device.

FIG. 2 is a flowchart of a method of providing visual guidance in item handling operations.

FIG. 3 is a diagram illustrating an example performance of blocks 205 and 210 of the method of FIG. 2.

FIG. 4 is a diagram illustrating visual guide data obtained in an example performance of block 210 of the method of FIG. 2.

FIG. 5 is a diagram illustrating an example performance of block 220 of the method of FIG. 2.

FIG. 6 is a diagram illustrating another example performance of block 220 of the method of FIG. 2.

FIG. 7 is a diagram illustrating an example performance of block 235 of the method of FIG. 2.

FIG. 8 is a diagram illustrating an example performance of block 240 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a computing device including: obtaining a task definition including an item identifier; obtaining visual guide data associated with the task definition, the visual guide data including: (i) a reference image depicting an area of a facility corresponding to the identified item, and (ii) a guide element indicating a location for the identified item within the area; and presenting the visual guide data on a display located in an area distinct from the area of the facility corresponding to the identified item.

Additional examples disclosed herein are directed to a computing device, comprising: a display; and a processor configured to: obtain a task definition including an item identifier; obtain visual guide data associated with the task definition, the visual guide data including: (i) a reference image depicting an area of a facility corresponding to the identified item, and (ii) a guide element indicating a location for the identified item within the area; and present the visual guide data on the display while the computing device is located in an area distinct from the area of the facility corresponding to the identified item.

Further examples disclosed herein are directed to a method in a computing device, the method comprising: obtaining a task definition including an item identifier; obtaining visual guide data associated with the task definition, the visual guide data including: (i) a reference image depicting an area of a facility corresponding to the identified item, and (ii) a guide element indicating a location for the identified item within the area; presenting the visual guide data on a display; in response to detecting a task completion associated with the task definition, determining whether to obtain updated visual guide data; and in response to determining to obtain updated visual guide data, capturing an updated reference image depicting at least a portion of the area.

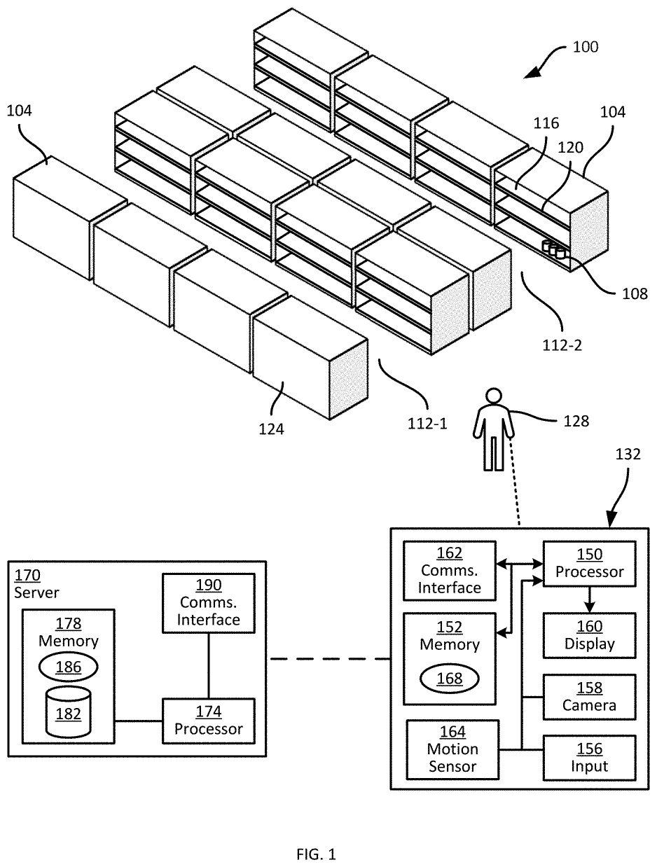

FIG. 1 illustrates an interior of a facility 100, such as a retail facility (e.g., a grocer). In other examples, the facility 100 can be a warehouse, a healthcare facility, a manufacturing facility, or the like. The facility 100 includes a plurality of support structures 104, such as shelf modules, carrying items 108. In the illustrated example, the support structures 104 are arranged in sets forming aisles 112. FIG. 1, specifically, illustrates two aisles 112-1, and 112-2 (i.e. individual instances of aisles 112), each formed by eight support structures 104. The facility 100 can have a wide variety of layouts other than the example layout shown in FIG. 1.

The support structures 104 include support surfaces 116, such as shelves, pegboards, and the like, to support the items 108 thereon. The support surfaces 116, in some examples, terminate in shelf edges 120, which face into the corresponding aisle 112. A shelf edge 120, as will be apparent to those skilled in the art, is a surface bounded by adjacent surfaces having different angles of inclination. In the example illustrated in FIG. 1, each shelf edge 120 is at an angle of about ninety degrees relative to the corresponding support surface 116 above that shelf edge 120 and the underside (not shown) of the support surface 116. In other examples, the angles between a shelf edge 120 and adjacent surfaces is more or less than ninety degrees.

The support surfaces 116 carry the items 108, which can include products for retrieval by customers, workers and the like in the facility. As seen in FIG. 1, the support surfaces 116 are accessible from the aisle 112 into which the shelf edges 120 face. In some examples, each support structure 104 has a back wall 124 rendering the support surfaces 116 inaccessible from the side of the support structure 104 opposite the shelf edges 120. In other examples, however, the support structure 104 can be open from both sides (e.g., the back wall 124 can be omitted).

As will be apparent, the facility 100 may contain a wide variety of items 108 disposed on the support structures 104. For instance, a retail facility such as a grocer may contain tens of thousands of distinct products. A given product may be referred to as an item type, such that a support surface 116 may support a number of individual instances of items 108 of the same type, e.g., in one or more facings.

Various tasks associated with the items 108 may take place in the facility. For example, items 108 may be retrieved by staff within the facility, e.g., to fulfill online orders placed by customers. In other examples, an item type may be restocked on a support structure 104 via the retrieval of one or more items 108 of the relevant type from one area of the facility (e.g., a stock room, loading dock, or the like), and placement of the retrieved items 108 at a particular location on the support structures 104.

The above tasks can be performed by facility staff, such as a worker 128, with or without assistance from autonomous or semi-autonomous devices (e.g., a fleet of collaborative robots, or cobots). The worker 128 may, to complete a pick task for fulfilling an online order placed by a customer of the facility, be instructed to retrieve specified quantities of one or more of the items 108. The size of the facility and/or the number of available items 108 in the facility may complicate locating and retrieving the relevant items 108 by the worker 128. In particular, in the absence of guidance, the worker 128 may travel to one or more incorrect locations within the facility while searching for a particular item 108. Tasks such as restocking, online order fulfillment and the like may therefore be delayed.

Certain computing devices are therefore deployed in the facility 100 to assist the worker 128 in completing tasks such as order fulfillment and restocking, as mentioned above. In particular, the worker 128 can be provided with a computing device, such as a mobile computing device 132. The mobile computing device 132, also referred to simply as the device 132, can be a tablet computer, a smart phone, a wearable computing device, or a combination thereof.

Certain internal components of the device 132 are illustrated in FIG. 1. In particular, the device 132 includes a special-purpose controller, such as a processor 150, interconnected with a non-transitory computer readable storage medium, such as a memory 152. The memory 152 includes a combination of volatile memory (e.g., Random Access Memory or RAM) and non-volatile memory (e.g., read only memory or ROM, Electrically Erasable Programmable Read Only Memory or EEPROM, flash memory). The processor 150 and the memory 152 each comprise one or more integrated circuits.

The device 132 also includes at least one input device 156 interconnected with the processor 150. The input device 156 is configured to receive input and provide data representative of the received input to the processor 150. The input device 156 includes any one of, or a suitable combination of, a touch screen, a keypad, a trigger button, a microphone, and the like. In addition, the device 132 includes a camera 158 including a suitable image sensor or combination of image sensors. The camera 158 is controllable by the processor 150 to capture images (e.g., single frames or video streams including sequences of image frames). The camera 158 can include either or both of a two-dimensional camera, and a three-dimensional camera such as a stereo camera assembly, a time-of-flight camera, or the like. In other words, the camera 158 can be enabled to capture either or both of color data (e.g., values for a set of color channels) and depth data.

The device 132 also includes a display 160 (e.g., a flat-panel display integrated with the above-mentioned touch screen) interconnected with the processor 150, and configured to render data under the control of the processor 150. The device 132 can also include one or more output devices in addition to the display 160, such as a speaker, a notification LED, and the like (not shown).

The device 132 also includes a communications interface 162 interconnected with the processor 150. The communications interface 162 includes any suitable hardware (e.g., transmitters, receivers, network interface controllers and the like) allowing the client device 132 to communicate with other computing devices via wired and/or wireless links (e.g., over local or wide-area networks). The specific components of the communications interface 162 are selected based on the type(s) of network(s) or other links employed by the device 132.

Further, the device 132 can include a motion sensor 164, such as an inertial measurement unit (IMU) including one or more accelerometers, one or more gyroscopes, and/or one or more magnetometers. The motion sensor 164 is configured to generate data indicating detected movement of the device 132 and provide the data to the processor 150, for example to enable the processor 150 to perform the pose tracking mentioned earlier.

The memory 152 stores computer readable instructions for execution by the processor 150. In particular, the memory 152 stores a task guidance application 168 (also referred to simply as the application 168) which, when executed by the processor 150, configures the processor 150 to perform various functions discussed below in greater detail. In general, those functions configure the device 132 to present visual guidance to the worker 128, to facilitate the completion of tasks such as order fulfillment and restocking. The visual guidance can include, for example, reference images depicting portions of the facility, along with guide elements overlaid or otherwise accompanying the reference images, indicating the locations of specific items 108. The application 168 may also be implemented as a suite of distinct applications in other examples. Those skilled in the art will appreciate that the functionality implemented by the processor 150 via the execution of the application 168 may also be implemented by one or more specially designed hardware and firmware components, such as FPGAs, ASICs and the like in other embodiments.

The visual guidance mentioned above, also referred to herein as visual guide data, can be presented by the device 132 to the worker 128, e.g., while the worker 128 is in transit towards the location indicated by the visual guide data. The visual guide data may therefore facilitate location of the relevant item(s) 108 by the worker 128, e.g., by depicting visual cues, landmarks or the like that appear in the facility. Having viewed such visual features in the reference images, the worker 128 may then readily recognize those features upon approaching the location where the relevant item 108 is stored.

The visual guide data can be obtained from a repository, which may be stored at the device 132 itself (e.g., in the memory 152), or at a separate computing device. As illustrated in FIG. 1, a computing device such as a server 170 is deployed in association with the facility 100 (e.g., physically located within the facility, or located outside the facility and connected thereto by one or more communication networks). The server 170 includes a processor 174, interconnected with a memory 178 storing a repository 182 that contains the above-mentioned visual guide data. The memory 178 also stores an application 186, execution of which by the processor 174 configures the server 170 to allocate tasks and accompanying visual guide data to the device 132. The server 170 also includes a communications interface 190, enabling the server 170 to communicate with other computing devices, including the device 132, e.g., via one or more networks deployed within the facility 100.

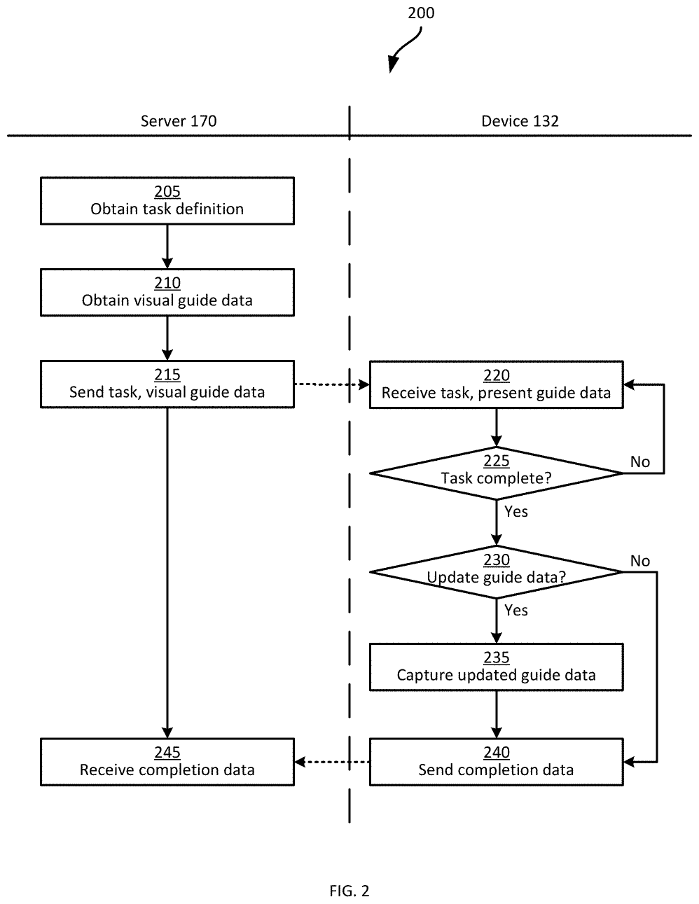

Turning to FIG. 2, a method 200 of providing visual guidance in item handling operations is illustrated. The method 200 will be discussed below in conjunction with its performance within the facility 100 as set out above. In particular, certain blocks of the method 200 are shown as being performed by the server 170, while other blocks are shown as being performed by the device 132. In some implementations, as noted in the discussion below, certain blocks of the method 200 can be performed by the device 132 instead of the server 170, or vice versa.

At block 205, the server 170 is configured to obtain a task definition. The task definition can be obtained at the server 170 by receiving the task definition from another device, or by generating the task definition locally. For instance, the task definition may be generated in response to receipt of an online order from a customer, or other external input to the server 170. In other examples, the device 132 can perform block 205, e.g., receiving the task definition directly from another computing device.

The task definition includes at least an item identifier, e.g., of one of the items 108. The item identifier can include a universal product code (UPC) or other suitable identified, sufficient to distinguish at least a particular item type from the item types present in the facility 100. In some examples, the item identifier can further identify one specific item 108, to distinguish that item 108 from other items 108 of the same type.

In general, the task definition specifies an item handling operation to be performed with respect to the identified item 108 or item type. The task definition can therefore also include other information, depending on the nature of the task. For example, the task definition can specify a type of the item handling operation, such as a pick operation (e.g., retrieve the identified item from the support structures 104). In other examples, the item handling operation can include a restocking operation, e.g., in which the identified item is to be retrieved from a stock room or the like in the facility 100, and transported to the support structures 104 for placement thereon. The task definition may also specify information such as a quantity of the identified item type to be handled.

In response to receiving the task definition at block 205, the server 170 is configured to obtain visual guide data corresponding to the task definition, at block 210. In some examples, such as that illustrated in FIG. 1, in which the server 170 itself stores the repository 182, the server 170 can retrieve the visual guide data from the repository 182. In other examples, the server 170 can generate at least a portion of the visual guide data, e.g., based on the contents of the repository 182. In further examples, e.g., where the repository 182 is stored at a distinct computing device, the server 170 can obtain the visual guide data by receiving the visual guide data from that other computing device. Still further, in some examples, the device 132 itself can perform block 210. For example, the device 132 can store the repository 182 or a copy thereof in the memory 152, and can therefore retrieve and/or generate the visual guide data locally.

The visual guide data includes at least an image depicting an area of the facility 100 containing the item identified in the task definition from block 205. To that end, the repository 182 includes item data defining item identifiers and corresponding locations of the items 108 in the facility 100. The locations can be, for example specific locations for each instance of a given item type (e.g., one facing), or a location within which all facings of a given item type are expected to appear, when those facings are contiguous. The locations mentioned above are stored in the form of coordinates in a previously established facility coordinate system. In some examples, rather than coordinates in such a system, the repository 182 can include a planogram or other suitable dataset specifying the position of each item 108 on the support structures 104, and a further dataset specifying the locations of each support structure 104 in the facility coordinate system. The coordinates of each item 108 in the facility coordinate system can therefore readily be derived from the above data.

The repository 182 also contains images depicting respective areas of the facility 100. In some examples, the images collectively depict the entirety of the aisles 112. In other examples, however, only certain portions of the aisles 112 or other portions of the facility 100 may be depicted in the images in the repository 182. Each image in the repository 182 is associated with location data, indicating the coordinates of the depicted area in the above-mentioned coordinate system. The images can be any one of, or a combination of, photographs captured by the device 132 or other devices deployed in the facility 100, photographs captured by an autonomous or semi-autonomous vehicle equipped with image sensors and configured to traverse the facility 100 capturing images of the support structures, or the like. The images can also include, in addition to or instead of the above, artificial renderings (e.g., generated from the above-mentioned planogram) depicting various areas of the facility 100.

Obtaining the visual guide data at block 210 therefore includes determining a location of the item 108 identified in the task definition from block 205, e.g., by looking up the location in the repository 182. Once the location of the item 108 has been retrieved, obtaining the visual guide data at block 210 includes selecting one or more images from the repository 182 that depict areas of the facility 100 containing the item's location.

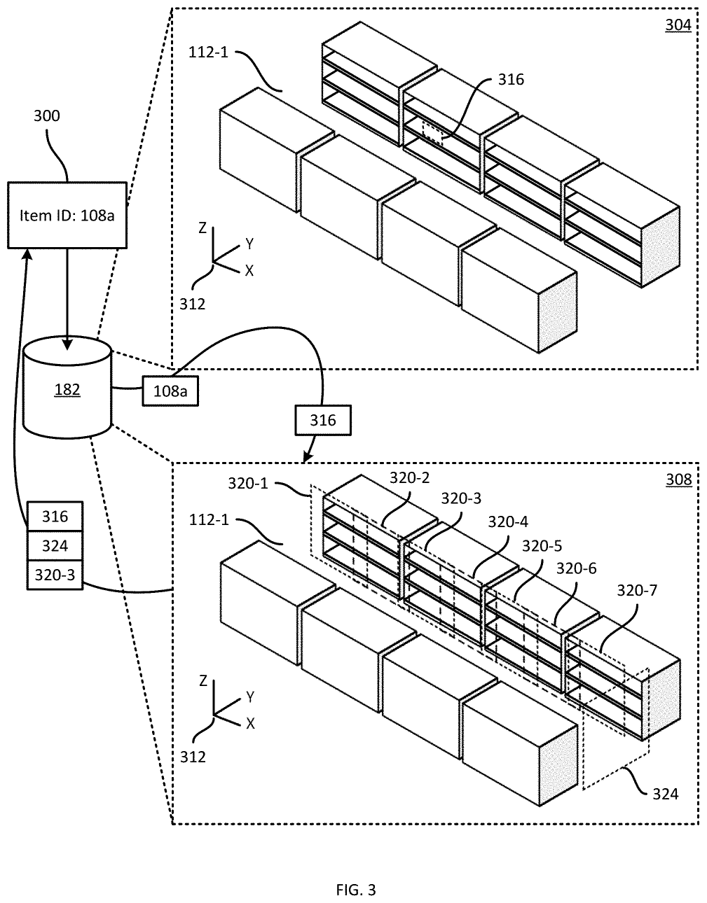

Turning to FIG. 3, an example performance of block 210 is illustrated. In particular, a query 300 (e.g., generated by the processor 174, or by the processor 150 when the device 132 itself performs block 210) including at least an item identifier “108a” is provided to the repository 182. The repository 182, as noted above, includes item location data 304, and image data 308. The item location data 304 includes, for each item 108, locations of the items in a facility coordinate system 312. For example, the item with the identifier “108a” has a location 316 on the support structures 104 of the aisle 112-1, as shown in FIG. 3. As will be apparent to those skilled in the art, although the location data 304 is depicted graphically in FIG. 3, the location data 304 can be stored in a wide variety of formats, which need not be graphical.

The location 316 can then be used to query the image data 308. The image data 308 contains a plurality of images each depicting a particular area of the facility 100. The areas depicted by each image can be stored with the respective image, e.g., in the form of a set of coordinates in the coordinate system 312. The coordinates can define two-dimensional areas, or three-dimensional volumes. For example, as shown in FIG. 3 the image data 308 includes a set of images 320 (specifically, images 320-1, 320-2, 320-3, 320-4, 320-5, 320-6, and 320-7) each depicting respective areas of the support structures along one side of the aisle 112-1. The image data 308 also includes an image 324 depicting some or all of the aisle 112-1, e.g., taken from one end of the aisle 112-1 and looking down the aisle 112-1. The images 320 and 324 are also referred to as reference images. In some examples, the repository 182 can also contain one or more additional images depicting still larger areas than aisles 112, such as an overhead map of the facility 100.

As seen by comparing the item location data 304 with the image data 308, the location 316 falls within the area depicted by the image 320-3, as well as within the larger area depicted by the image 324. The server 170 can therefore select either or both of the images 320-3 and 324 at block 210. For example, the server 170 can be configured to select a first image depicting an area that contains the location 316 (i.e., the image 320-3 in this example), and to also select another image if that image depicts a larger area than the first (i.e., the image 324 in this example).

The result of the query 300 therefore includes, as shown in FIG. 3, the location 316 (e.g., coordinates defining the location 316), as well as the selected images 320-3 and 324. The server 170 also, in some examples, generates a guide element for presentation at the device 132, along with the images 320-3 and 324. The guide element, in the present embodiment, includes one or more overlays for the above-mentioned images, indicating the location 316 within the area(s) depicted by each image.

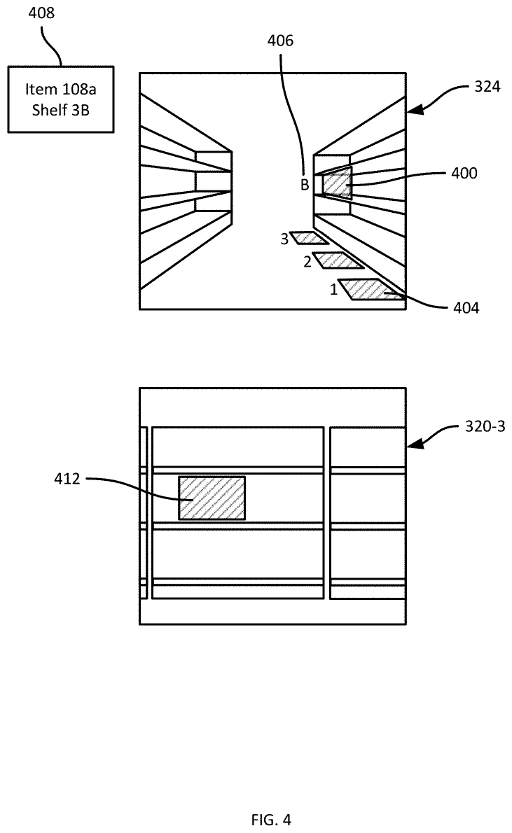

For example, turning to FIG. 4, the images 320-3 and 324 are shown, along with respective guide elements generated by the server 170. For example, the server 170 can generate a first guide element 400 depicting the location 316 within the area depicted by the image 324 (i.e., within the aisle 112-1, in this example). The guide element 400 can include a translucent overlay at the location 316, a colored boundary around the location 316, or the like. The server 170 can also, as shown in FIG. 4, generate additional guide elements, such as markers 404 and 406 which may correspond to labels or other visible features of the support structures 104 that may not be clearly depicted in the image 324 itself, but that are visible to the worker 128. For example, the markers 404 may indicate portions along a length of the aisle 112-1, and the marker 406 may indicate one of the support surfaces 116. The guide elements generated by the server 170 can further include an auxiliary element 408, e.g., specifying the location of the item 108 in terms corresponding to the markers 406 and 408 (e.g., displaying the location “3B”).

The server 170 also generates, in this example performance of block 210, a guide element corresponding to the image 320-3, e.g., in the form of a translucent overlay at the location 316. As noted above, other forms of guide element can also be generated, such as bounding boxes and the like.

In some implementations, one or more of the guide elements 400, 404, 406, 408, and 412 can be pre-generated and stored in the repository 182. For example, a set of guide elements can be generated for each item 108, for each image, and stored along with the image data 308. At block 210, the guide elements can then be retrieved along with the images, rather than being generated substantially in real-time.

Returning to FIG. 2, at block 215, the server 170 is configured to send the task definition from block 205 (or at least a portion thereof) and the visual guide data from block 210, to the device 132. In implementations where the device 132 itself obtains either or both of the task definition and the visual guide data, the transmission at block 215 may be limited or omitted accordingly.

At block 220, the device 132 is configured to receive the task definition and the visual guide data (either by transmission from the server 170, or by local retrieval and/or generation, as noted above). In response to receiving the task definition and visual guide data, the device 132 is further configured to present at least one of the images in the visual guide data.

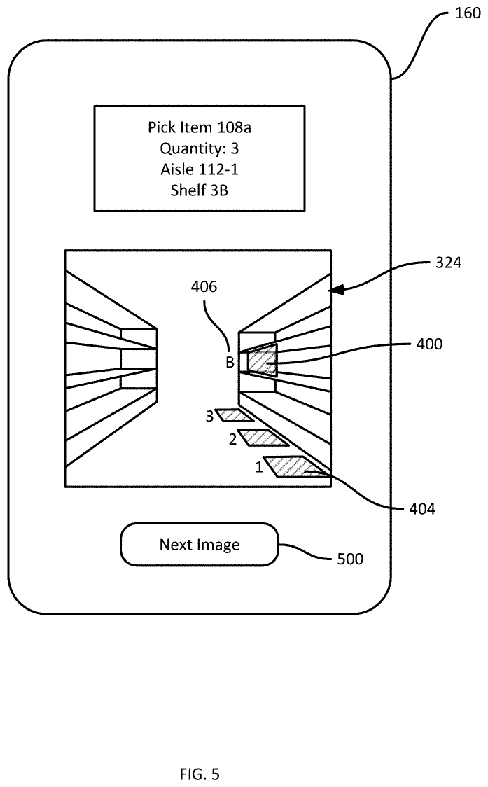

For example, turning to FIG. 5, the display 160 is shown following receipt of the task definition and visual guide data from the server 170. The display 106 is controlled, e.g., by the processor 150 via execution of the application 168, to present at least one of the images 320-3 and 324 and the associated guide elements. Thus, in the illustrated example, the processor 150 controls the display 160 to present the image 324 and the guide elements 400, 404, and 406.

To select the image 324 as opposed to the image 320-3, the processor 150 can be configured to select the image depicting the largest area for initial display. Thus, in this example the image 324 is selected because the image 324 depicts substantially the entire aisle 112-1, which encompasses the area depicted by the image 320-3. In other examples, e.g., depending on the available display space at the device 132, the processor 150 can control the display 160 to present more than one of the images received at block 220.

As seen in an upper portion of the display 160, the display 160 can also be controlled to present task information, such as the item identifier and some or all of the guide element 408. The display 160 can also present, as shown in FIG. 4, a selectable element 500. Selection of the element 500 (e.g., via the previously mentioned touch screen) causes the processor 150 to present the image 320-3, e.g., instead of the image 324. In other examples, the processor 150 may monitor a current location of the device 132 within the facility 100 (e.g. via the motion sensor 164) and switch to the image 320-3 when the device 132 comes within a predefined distance of the aisle 112-1, indicating that the worker 128 is approaching the aisle 112-1.

More generally, detection of a selection of the element 500 to switch images can be implemented as the detection of an intermediate stage completion associated with the task definition. The intermediate stage can be, for example, travel to within a predefined distance of the location 316 as noted above. The intermediate stage can also be, in other examples, the scanning of an item to be transported to the location 316, e.g., for a restocking task.

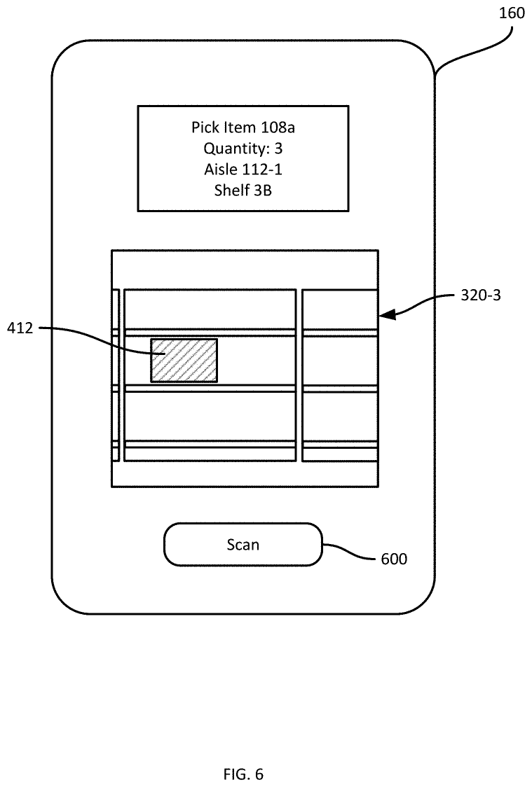

Referring again to FIG. 2, at block 225 the processor 150 is configured to determine whether the task set out in the task definition received at block 220 is complete. Completion may be indicated by scanning of a barcode on the relevant item 108, selection of an input at the device 132, or the like. When the determination is negative at block 225, the device 132 can continue presenting the visual guide data at block 220 as discussed above, including the detection of intermediate stage completions and presentation of additional images from the set received at block 220. For example, FIG. 6 illustrates a further performance of block 220, e.g., after a selection of the element 500. The image 320-3 is displayed, along with the guide element 412, and the element 500 is replaced with a selectable element 600 to initiate a barcode scan or other operation used to confirm completion of the task (e.g., retrieval of the relevant item 108 for a pick task, placement of the item for a restocking task, or the like).

When the determination at block 225 is affirmative, the device 132 proceeds to block 230. At block 230, the device 132 is configured to determine whether to update the visual guide data received at block 220. The determination at block 230 can be a determination of whether to update one or more of the reference images received at block 220. For example, the images 320-3 and/or 324 can include metadata specifying a capture date and/or time, and the device 132 can determine whether the age of either the images (e.g., a difference between the current date and the capture date) exceeds a predetermined threshold. When an image is sufficiently aged, the determination at block 230 is affirmative, and the device 132 proceeds to block 235.

In other examples, the server 170 can make the above-noted determination, and send an instruction to the device 132 to obtain updated guide data, e.g., with the data sent at block 215. In further examples, the determination at block 230 can be omitted, and the device 132 can proceed directly to block 235 regardless of the age of the images from block 220.

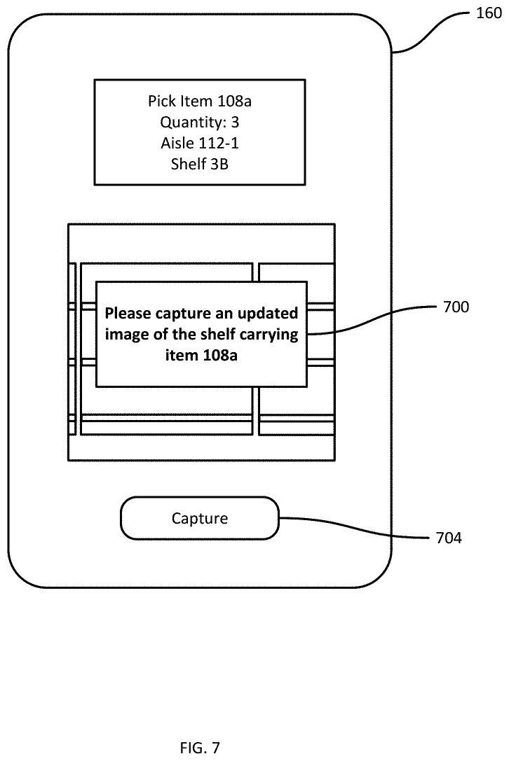

At block 235, the device 132 is configured to capture updated guide data, in the form of one or more images. For example, as shown in FIG. 7, the processor 150 can control the display 160 to present a prompt 700 instructing the worker 128 to capture an image of the support structure(s) 104 encompassing the location 316. The display 160 may present, for example, a selectable element 704 to activate the camera 158 to capture the image. The above prompt may be repeated for other images, if more than one image is to be updated. For example, a further prompt may instruct the worker 128 to capture an image of the aisle 112-1 as a whole, to replace the image 324 in the repository 182. The images captured at block 235 can be associated with locations in the coordinate system 312, e.g. via data collected by the motion sensor 164 tracking the location of the device 132 within the facility 100.

In response to capturing the updated guide data at block 235, or in response to a negative determination at block 230, the device 132 proceeds to block 240. At block 240, the device 132 is configured to send completion data to the server 170. The completion data indicates either or both of completion of the item handling operation defined by the task definition from block 205, and updated guide data from block 235.

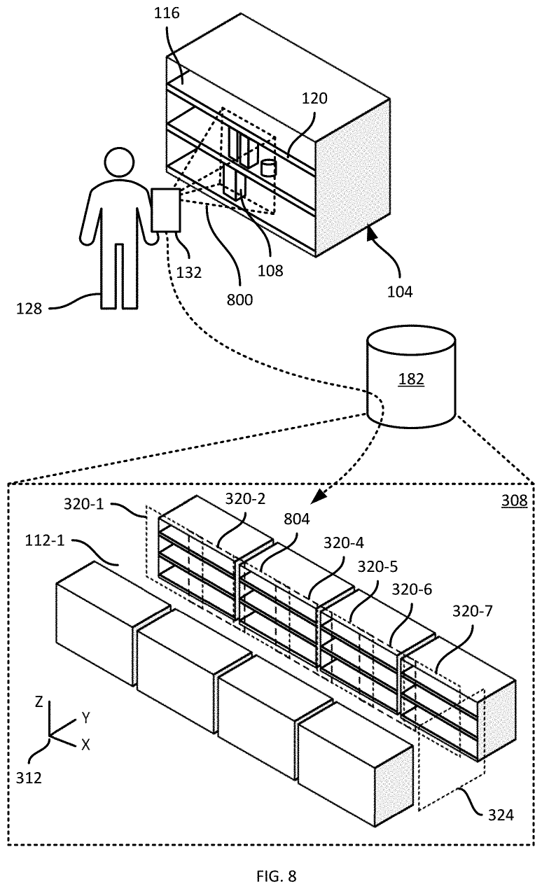

For example, FIG. 8 illustrates the capture of an image at block 235, encompassing a portion of a support structure 104 within a field of view 800 of the camera 158, and the transmission of the image (e.g., to the server 170) for storage in the repository 182. For example, an image 804 resulting from the above capture can replace the image 320-3 in the repository. That is, at block 245 the server 170 can receive the updated guide data (and task completion data), and update the repository 182. In other examples, e.g., in which the device 132 itself stores the repository 182, the device 132 can update the repository 182 locally.

In other implementations, the method 200 can be performed for a set of tasks. For example, two or more task definitions can be obtained at block 205, and visual guide data can be obtained for each task at block 210. Multiple tasks and corresponding sets of visual guide data can therefore be provided to the device at block 220, and the device can cycle through the visual guide data for each task as noted above, e.g., with a selectable list of the tasks received.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a computing device, the method comprising:
obtaining a task definition including an item identifier;
obtaining visual guide data associated with the task definition, the visual guide data including:
(i) a reference image depicting an area of a facility corresponding to the identified item, and
(ii) a guide element indicating a location for the identified item within the area; and
presenting the visual guide data on a display located in an area distinct from the area of the facility corresponding to the identified item.

2. The method of claim 1, wherein obtaining the task definition includes receiving the item identifier from a server.

3. The method of claim 2, wherein determining whether to obtain updated visual guide data includes:
receiving an instruction from the server to obtain updated visual guide data.

4. The method of claim 2, further comprising:
sending task completion data and the updated reference image to the server.

5. The method of claim 1, wherein determining whether to obtain updated visual guide data includes:
determining whether an age of the reference image exceeds a threshold.

6. The method of claim 1, wherein obtaining the visual guide data includes:
determining the location of the identified item; and
retrieving the visual guide data from a repository based on the location.

7. The method of claim 1, wherein obtaining the visual guide data includes:
receiving the visual guide data from a server.

8. The method of claim 1, wherein the visual guide data includes:
(i) a first reference image depicting a first area, and a first guide element indicating the location of the identified item within the first area, and
(ii) a second reference image depicting a second area within the first area, and a second guide element indicating the location of the identified item with the second area.

9. The method of claim 8, wherein presenting the visual guide data includes:
presenting the first reference image and the first guide element;
detecting an intermediate stage completion associated with the task definition; and
in response to detecting the intermediate stage completion, presenting the second reference image and the second guide element.

10. The method of claim 1, wherein the guide element includes an overlay on the reference image.

11. The method of claim 1, wherein the display is mobile; and
wherein presenting the visual guide data on the display includes presenting the visual guide data prior to arrival of the display in the area of the facility corresponding to the identified item.

12. The method of claim 1, further comprising:
in response to detecting a task completion associated with the task definition, determining whether to obtain updated visual guide data; and
in response to determining to obtain updated visual guide data, capturing an updated reference image depicting at least a portion of the area.

13. A computing device, comprising:
a display; and
a processor configured to:
obtain a task definition including an item identifier;
obtain visual guide data associated with the task definition, the visual guide data including:
(i) a reference image depicting an area of a facility corresponding to the identified item, and
(ii) a guide element indicating a location for the identified item within the area; and
present the visual guide data on the display while the computing device is located in an area distinct from the area of the facility corresponding to the identified item.

14. The computing device of claim 13, wherein the processor is configured, to obtain the task definition, to receive the item identifier from a server.

15. The computing device of claim 14, wherein the processor is configured, to determine whether to obtain updated visual guide data, to:
receive an instruction from the server to obtain updated visual guide data.

16. The computing device of claim 14, wherein the processor is further configured to:
send task completion data and the updated reference image to the server.

17. The computing device of claim 13, wherein the processor is configured, to determine whether to obtain updated visual guide data, to:
determine whether an age of the reference image exceeds a threshold.

18. The computing device of claim 13, wherein the processor is configured, to obtain the visual guide data, to:
determine the location of the identified item; and
retrieve the visual guide data from a repository based on the location.

19. The computing device of claim 13, wherein the processor is configured, to obtain the visual guide data, to:
receive the visual guide data from a server.

20. The computing device of claim 13, wherein the visual guide data includes:
(i) a first reference image depicting a first area, and a first guide element indicating the location of the identified item within the first area, and
(ii) a second reference image depicting a second area within the first area, and a second guide element indicating the location of the identified item with the second area.

21. The computing device of claim 20, wherein the processor is configured, to present the visual guide data, to:
present the first reference image and the first guide element;
detect an intermediate stage completion associated with the task definition; and
in response to detecting the intermediate stage completion, present the second reference image and the second guide element.

22. The computing device of claim 13, wherein the guide element includes an overlay on the reference image.

23. The computing device of claim 13, wherein the processor is configured to present the visual guide data prior to arrival of the computing device in the area of the facility corresponding to the identified item.

24. The computing device of claim 13, wherein the processor is further configured to:
in response to detecting a task completion associated with the task definition, determine whether to obtain updated visual guide data; and
in response to determining to obtain updated visual guide data, capture an updated reference image depicting at least a portion of the area.

25. A method in a computing device, the method comprising:
obtaining a task definition including an item identifier;
obtaining visual guide data associated with the task definition, the visual guide data including:
(i) a reference image depicting an area of a facility corresponding to the identified item, and
(ii) a guide element indicating a location for the identified item within the area;
presenting the visual guide data on a display;
in response to detecting a task completion associated with the task definition, determining whether to obtain updated visual guide data; and
in response to determining to obtain updated visual guide data, capturing an updated reference image depicting at least a portion of the area.
